(19) United States
(12) Patent Application Publication
(10) Pub. No.: US 2024/0155374 A1
(43) Pub. Date: May 9, 2024

(54) SMALL DATA TRANSMISSIONS WITH BEAM SWITCHING FOR IDLE/INACTIVE STATE USER EQUIPMENT IN NON-TERRESTRIAL NETWORK

(71) Applicant: QUALCOMM Incorporated, San Diego, CA (US)

(72) Inventors: Chao WEI, Beijing (CN); Qiaoyu LI, Beijing (CN); Ruiming ZHENG, Beijing (CN); Hao XU, Beijing (CN)

(21) Appl. No.: 18/549,883

(22) PCT Filed: May 14, 2021
(86) PCT No.: PCT/CN2021/093808

§ 371 Date: Sep. 8, 2023

(51) Int. Cl. H04W 16/28; H04W 74/0833; H04W 76/20; H04W 84/06

(52) U.S. Cl. CPC H04W 16/28; H04W 74/0833; H04W 76/20; H04W 84/06

(57) ABSTRACT

A method of wireless communication by a user equipment (UE) in a non-terrestrial network (NTN) includes transmitting a first small data transmission to a base station during a first transmission occasion associated with a first NTN beam, while the UE remains in an inactive mode or idle mode. The method further includes identifying a switch from the first NTN beam to a second NTN beam. The method still further includes transmitting a subsequent small data transmission to the base station during a second transmission occasion associated with the second NTN beam.

### FIELD OF THE DISCLOSURE

The present disclosure relates generally to wireless communications, and more specifically to small data transmissions with beam switching for idle/inactive state user equipment in non-terrestrial networks.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by a user equipment (UE) in a non-terrestrial network (NTN) includes transmitting a first small data transmission to a base station during a first transmission occasion associated with a first NTN beam, while the UE remains in an inactive mode or idle mode. The method further includes identifying a switch from the first NTN beam to a second NTN beam. The method still further includes transmitting a subsequent small data transmission to the base station during a second transmission occasion associated with the second NTN beam.

In other aspects of the present disclosure, a method of wireless communication by a base station in a non-terrestrial network (NTN) includes receiving a first small data transmission from a user equipment (UE) during a first transmission occasion associated with a first NTN beam, while the UE remains in an inactive mode or idle mode. The method further includes switching from the first NTN beam to a second NTN beam. The method still further includes receiving a subsequent small data transmission from the UE during a second transmission occasion associated with the second NTN beam.

Other aspects of the present disclosure are directed to an apparatus for wireless communication by a user equipment (UE) having a memory, and one or more processors coupled to the memory. The processor(s) is configured to transmit a first small data transmission to a base station during a first transmission occasion associated with a first NTN beam, while the UE remains in an inactive mode or idle mode. The processor(s) is further configured to identify a switch from the first NTN beam to a second NTN beam. The processor(s) is still further configured to transmit a subsequent small data transmission to the base station during a second transmission occasion associated with the second NTN beam.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a diagram illustrating a non-terrestrial network (NTN) for wireless communications, in accordance with aspects of the present disclosure.

FIG. 4 is call flow diagram illustrating a four-step random access channel-based small data transmission (SDT) procedure.

FIG. 5 is a call flow diagram illustrating a configured grant (CG)-based small data transmission (SDT) procedure.

FIG. 6 is a diagram illustrating a user equipment (UE) traversing multiple beams from a satellite, in accordance with aspects of the present disclosure.

FIG. 7 is a call flow diagram illustrating location-based beam switching, in accordance with aspects of the present disclosure.

FIG. 8 is diagram illustrating a timeline for beam switching based on a random access channel (RACH) message, in accordance with aspects of the present disclosure.

FIG. 9 is a diagram illustrating a timeline for beam switching based on a physical uplink shared channel (PUSCH) message, in accordance with aspects of the present disclosure.

FIG. 10 is a flow diagram illustrating an example process performed, for example, by a user equipment (UE), in accordance with various aspects of the present disclosure.

FIG. 11 is a flow diagram illustrating an example process performed, for example, by a base station, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Non-terrestrial networks (NTNs) have been introduced for wireless communications. It is a goal to adapt new radio (NR) and 5G Internet of things (IoT) (such as enhanced machine type communication (eMTC) and narrowband Internet of things (NB-IoT)) communication standards to support non-terrestrial networks (NTNs). NTNs may include geostationary (GEO), medium Earth orbit (MEO), and low Earth orbit (LEO) satellites, as well as unmanned aircraft systems, providing moving or fixed beams on Earth. Satellites in the NTNs create multiple spot beams (also referred to as synchronization signal block (SSB) beams) covering different portions of a coverage area. Due to satellite movement, a user equipment (UE) may experience frequent switching of spot beams, even when the UE remains stationary.

UEs often generate a small amount of data during a data session. This type of data traffic may be applicable across all types of services, including mobile broadband (MBB) and IoT applications. Techniques would be desirable to enable idle or inactive mode UEs to send these small data transmissions (SDTs) without entering a connected mode of operation. Connected mode communications consume additional power compared to idle or inactive mode operations.

For small data transmissions in a cell with multiple SSB beams, a UE measures candidate beams in bandwidth part (BWP) zero. The UE then determines an SSB beam for an uplink transmission by measuring the reference signal receive power (RSRP) of candidate SSBs and selecting a candidate with an RSRP above a threshold. The UE may transmit user data during a first available uplink opportunity associated with the selected SSB beam based on a configured mapping between SSB beams and opportunities. Beam switching is not supported for small data transmissions for idle/inactive mode UEs.

In some cases, however, beam switching may be expected for small data transmissions in NTNs. For example, the UE may see different spot beams when transmitting uplink small data transmissions, such as when waiting a long time for an application layer acknowledgement (ACK) of a first uplink small data message prior to transmitting a second uplink small data transmission. In addition, beam switching may occur during a subsequent uplink small data transmission when the UE transmits the first uplink small data message while at the edge of the spot beam coverage.

According to aspects of the present disclosure, an idle or inactive mode UE determines its location, and reports its location when sending a first uplink small data transmission to a base station (gNB). Based on the location, the network may preconfigure a beam switching time along with beam layout information to the UE. The UE may identify the switching, without further network assistance, once the beam switching time arrives.

If, however, the UE has no capability to determine its location, an idle/inactive mode UE may initiate a beam switching request during uplink small data transmissions by using a contention-free random access channel (CF-RACH) procedure or a physical uplink shared channel (PUSCH) message. For example, if dedicated preconfigured uplink resources (D-PUR) exist for the UE for subsequent uplink small data transmissions, the network may configure dedicated RACH resources for UE initiated beam switching.

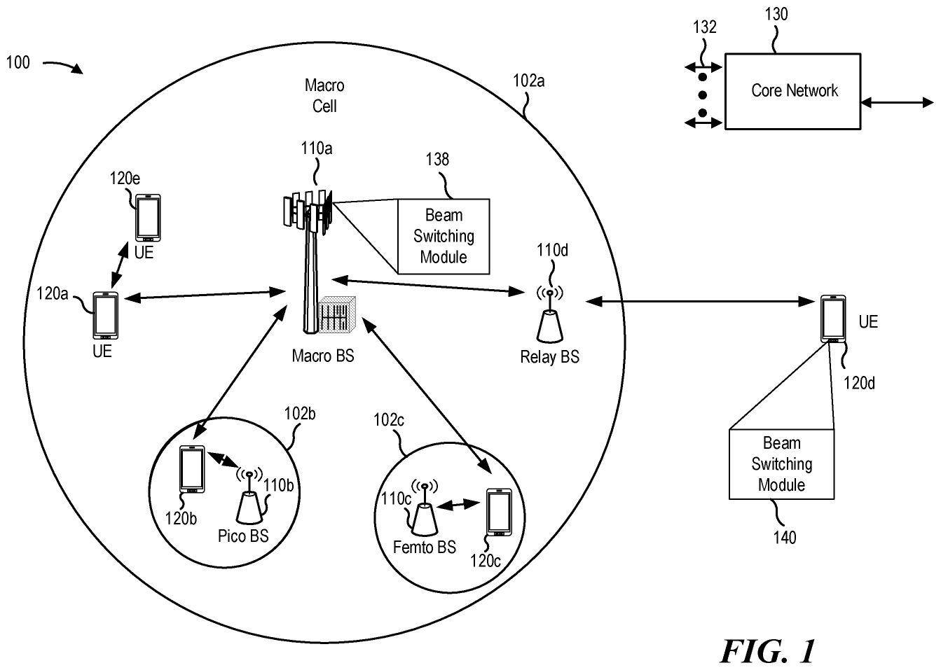

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. ABS is an entity that communicates with user equipment (UEs) and may also be referred to as a base station, an NR BS, a Node B, a gNB, a 5G node B (NB), an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

ABS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MIME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless communications system 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a beam switching module 140. For brevity, only one UE 120d is shown as including the beam switching module 140. The beam switching module 140 may transmit a first small data transmission to a base station during a first transmission occasion associated with a first NTN beam, while the UE remains in an inactive mode or idle mode. The beam switching module 140 may also identify a switch from the first NTN beam to a second NTN beam and transmit a subsequent small data transmission to the base station during a second transmission occasion associated with the second NTN beam.

The base stations 110 may include a beam switching module 138 to receive a first small data transmission from a user equipment (UE) during a first transmission occasion associated with a first NTN beam, while the UE remains in an inactive mode or idle mode. The beam switching module 138 may also switch from the first NTN beam to a second NTN beam, and receive a subsequent small data transmission from the UE during a second transmission occasion associated with the second NTN beam

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

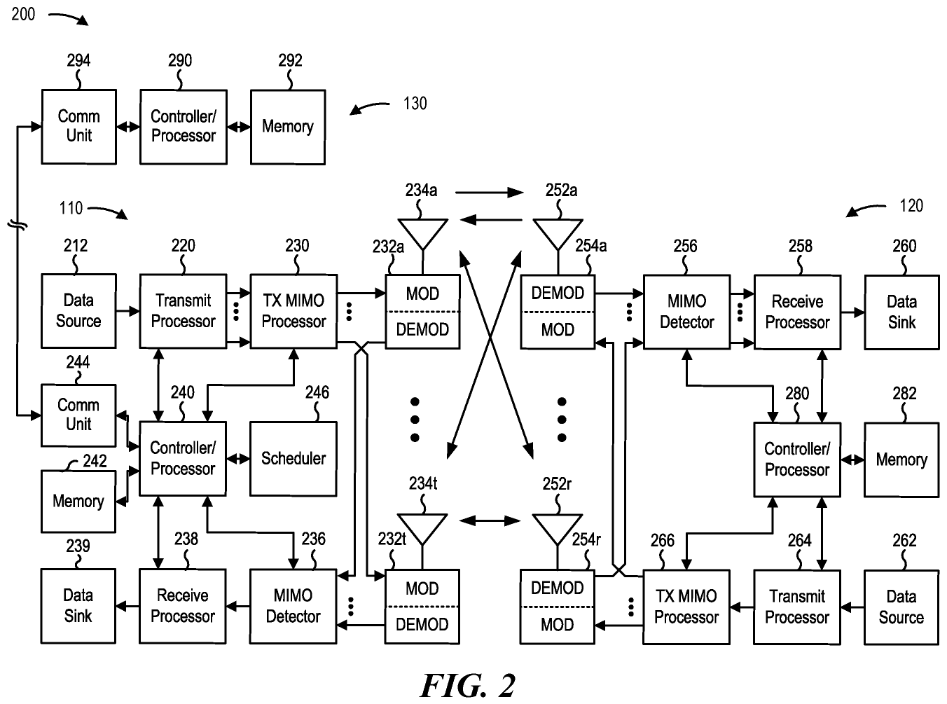

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

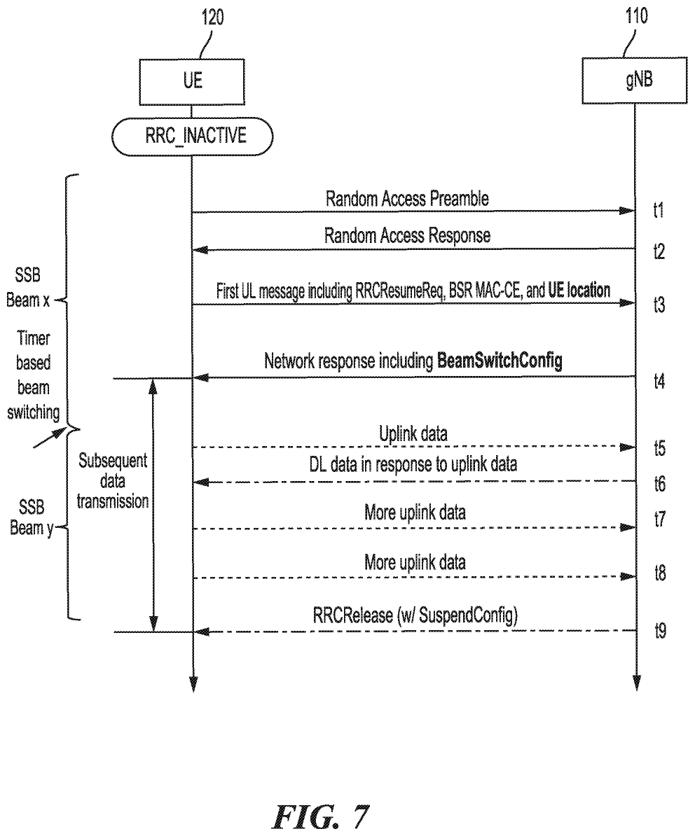

The controller/processor 240 of the base station 110, the controller/processor 280 of the UE 120, and/or any other component(s) of FIG. 2 may perform one or more techniques associated with NTN beam switching, as described in more detail elsewhere. For example, the controller/processor 240 of the base station 110, the controller/processor 280 of the UE 120, and/or any other component(s) of FIG. 2 may perform or direct operations of, for example, the process of FIGS. 7, 10, and 11 and/or other processes as described. Memories 242 and 282 may store data and program codes for the base station 110 and UE 120, respectively. A scheduler 246 may schedule UEs for data transmission on the downlink and/or uplink.

In some aspects, the UE 120 or base station 110 may include means for transmitting and means for identifying. In other aspects, the UE 120 or base station 110 may include means for receiving means for multiplexing, means for demultiplexing, and means for switching. Such means may include one or more components of the UE 120 or base station 110 described in connection with FIG. 2.

As indicated above, FIG. 2 is provided merely as an example. Other examples may differ from what is described with regard to FIG. 2.

Non-terrestrial networks (NTNs) have been introduced for wireless communications. It is a goal to adapt new radio (NR) and 5G Internet of things (IoT) (such as enhanced machine type communication (eMTC) and narrowband Internet of things (NB-IoT)) communication standards to support non-terrestrial networks (NTNs). NTNs may include geostationary (GEO), medium Earth orbit (MEO), and low Earth orbit (LEO) satellites, as well as unmanned aircraft systems, providing moving or fixed beams on Earth. The NTN may use frequency bands such as L, S, Ka, Ku, C, Q, and V for mobile communications.

Satellites in the NTNs create multiple spot beams (also referred to as synchronization signal block (SSB) beams) covering different portions of a coverage area. Due to satellite movement, a user equipment (UE) may experience frequent switching of spot beams, even when the UE remains stationary. In some cases, a spot beam from a low Earth orbit (LEO) satellite may only serve a UE for twenty seconds. Although the present description primarily refers to NTNs with respect to satellites, any type of unmanned aerial system is contemplated.

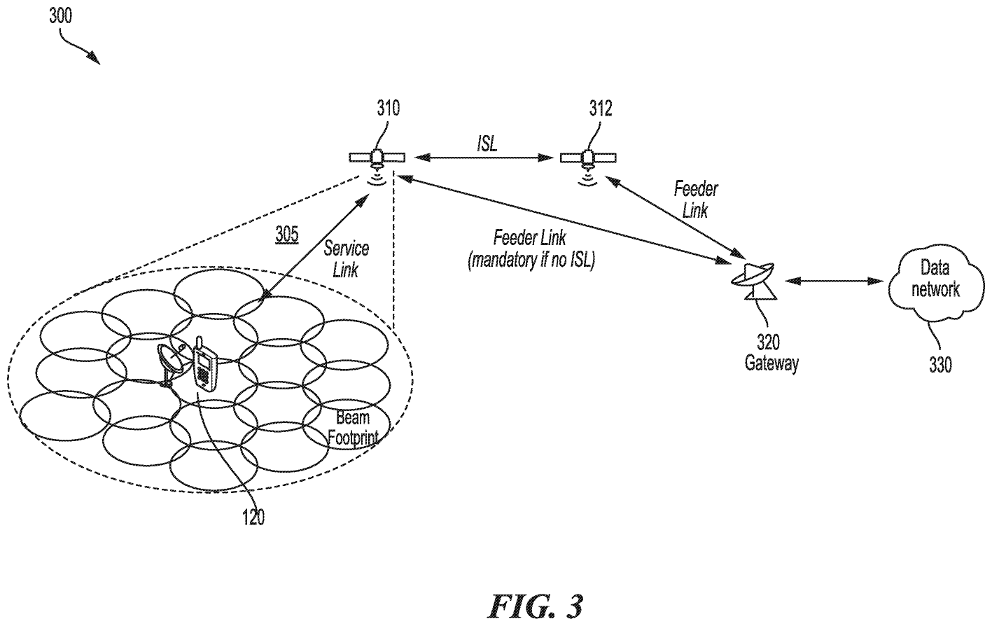

FIG. 3 is a diagram 300 illustrating a non-terrestrial network (NTN) for wireless communications, in accordance with aspects of the present disclosure. A UE 120 is within a coverage area 305 of a satellite 310 (or unmanned aerial system (UAS)). The coverage area 305 includes multiple beam footprints. The UE 120 communicates with the satellite 310 via a service link. In some aspects, the satellite 310 communicates with another satellite 312 via an inter-satellite link (ISL). A base station may be located at either satellite 310, 312, or on the ground. A gateway 320 operates as an interface between one of the satellites 310, 312 and a data network 330. The gateway 320 communicates with one or both of the satellites 310, 312 over a feeder link. The UE 120 is able to communicate with the data network 330 via the satellites 310, 312, gateway 320 and the ISL, service link, and feeder links.

UEs often generate a small amount of data during a data session. This type of data traffic may be applicable across all types of services, including mobile broadband (MBB) and IoT applications, such as instant messing software, social media software, wearable IOT devices, etc. Techniques would be desirable to enable idle or inactive mode UEs to send these small data transmissions (SDTs) without entering a connected mode of operation. Connected mode communications consume additional power compared to idle or inactive mode operations. Throughout the present description, the term ‘idle mode’ will be considered to also include an inactive mode and vice versa. The terms may be used interchangeably.

For small data transmissions in a cell with multiple synchronization signal block (SSB) beams, a UE measures candidate beams in bandwidth part (BWP) zero. The UE then determines an SSB beam for an uplink transmission by measuring the reference signal receive power (RSRP) of candidate SSBs and selecting a candidate with an RSRP above a threshold. The UE may transmit user data during a first available uplink opportunity associated with the selected SSB beam based on a configured mapping between SSB beams and opportunities. Beam switching is not supported for small data transmissions for idle/inactive mode UEs.

In some cases, however, beam switching may be expected for small data transmissions in NTNs. For example, the UE may see different spot beams when transmitting uplink small data transmissions, such as when waiting a long time for an application layer acknowledgement (ACK) of a first uplink small data message prior to transmitting a second uplink small data transmission. In addition, beam switching may occur during a subsequent uplink small data transmission when the UE transmits the first uplink small data message while at the edge of the spot beam coverage.

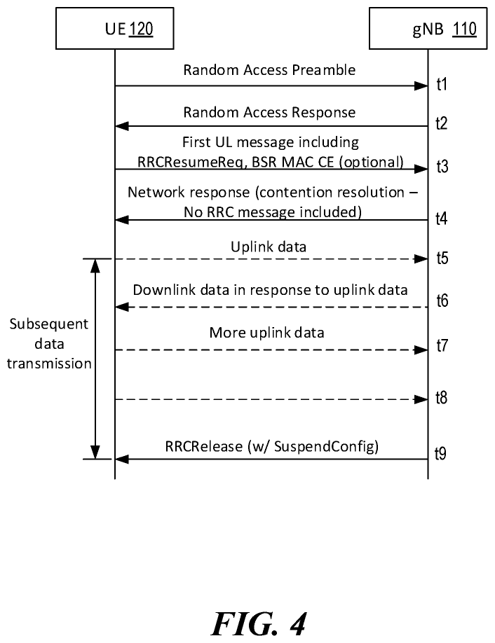

In a random access channel (RACH)-based SDT procedure, uplink small data messages may be transmitted from UEs in an inactive state. FIG. 4 is a block diagram illustrating a four-step random access channel-based small data transmission (SDT) procedure. At time t1, a UE 120 transmits a random access preamble to a base station 110. At time t2, the base station 110 responds with a random access response (RAR) message. At time t3, the UE 120 transmits a first uplink (UL) message with a small data transmission. As part of the first uplink transmission, the UE 120 includes an RRC resume request message, indicating the intent to resume a connection for the purpose of sending a small data transmission. Optionally, the UE 120 also sends a buffer status report (BSR) in a media access control-control element (MAC-CE). At time t4, the base station 110 responds with a network response message for contention resolution. In the example of FIG. 3, the network response message at time t4 may not include an RRC message.

Subsequent data transmissions begin at time t5, where the UE 120 sends an additional uplink small data transmission. At time t6, the base station 110 responds with downlink data in response to the received uplink data. At times t7 and t8, the UE 120 sends more uplink small data transmissions. Finally, at time t9, the base station 110 transmits an RRC release message, indicating a configuration for suspending the connection.

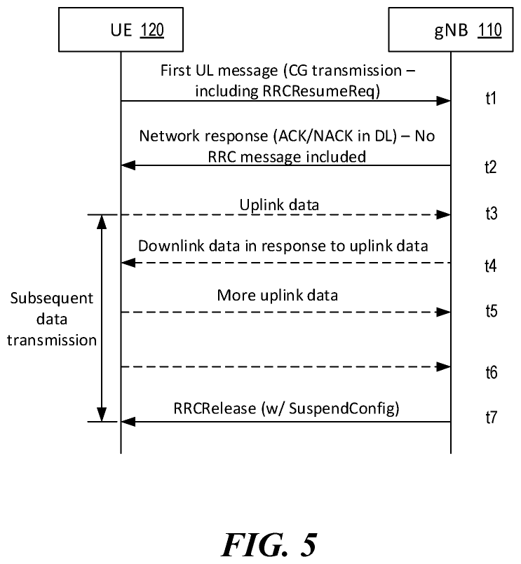

Small data transmissions can also occur with a configured grant (CG)-based procedure for inactive or idle mode UEs. FIG. 5 is a block diagram illustrating a configured grant-based small data transmission (SDT) procedure. In a configured grant-based SDT procedure, uplink data is transmitted on preconfigured physical uplink shared channel (PUSCH) resources. The UE may reuse a type one configured grant. In one example, a dedicated preconfigured uplink resource (D-PUR) is provided to the UE when the UE is in a CONNECTED state for first uplink small data transmission, and in inactive or idle mode for subsequent uplink small data transmissions. In another example, a D-PUR is provided to the UE when the UE is in an inactive or idle state for subsequent uplink small data transmissions.

Referring to FIG. 5, at time t1, a UE 120 transmits a first uplink (UL) message with a small data transmission to a base station 110. The first uplink message is a configured grant transmission including an RRC resume request message, indicating the intent to resume a connection for the purpose of sending a small data transmission. At time t2, the base station 110 responds with a network response message, which may be a downlink (DL) acknowledgement/negative acknowledgement (ACK/NAK) message. In the example of FIG. 5, the network response message at time t2 may not include an RRC message. Subsequent data transmissions begin at time t3, where the UE 120 sends an additional uplink small data transmission. At time t4, the base station 110 responds with downlink data in response to the received uplink data. At times t5 and t6, the UE 120 sends more uplink small data transmissions. Finally, at time t7, the base station 110 transmits an RRC release message, indicating a configuration for suspending the connection.

As seen in FIGS. 4 and 5, when all data cannot be transmitted at once, for subsequent small data transmissions, the UE may use either a dynamic grant or preconfigured PUSCH resources. State transition decisions for subsequent small data transmissions are controlled by the network. In the procedures described with respect to FIGS. 4 and 5, no beam switching occurs.

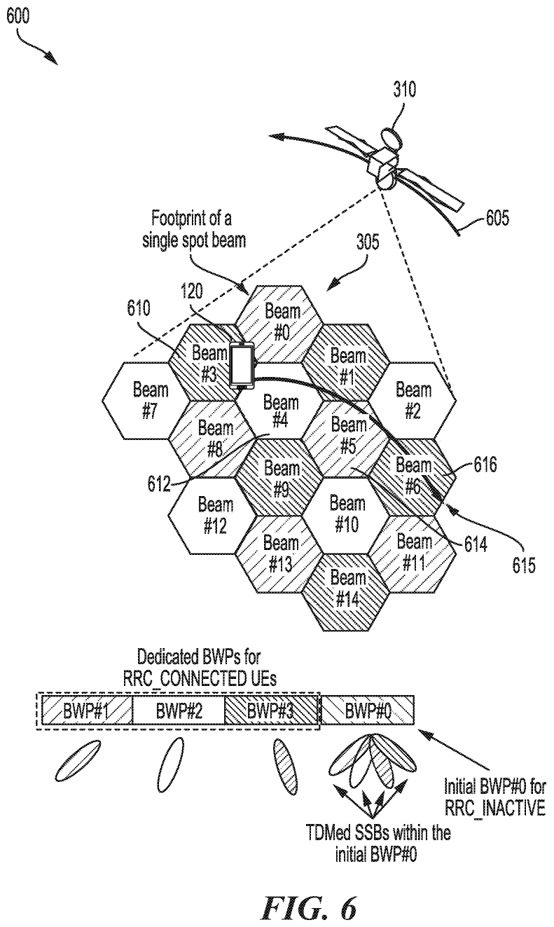

FIG. 6 is a diagram illustrating a user equipment (UE) 120 traversing multiple beams from a satellite 310, in accordance with aspects of the present disclosure. In the example of FIG. 6, a base station (not shown) is present in the satellite 310. For NTN communications, the satellite 310 may use multiple antennas to form multiple spot beams (also referred to as SSB beams) including beams 610, 612, 614, 616 to cover different portions of a cell 305. In other words, one cell 305 may consist of multiple satellite beams, including beams 0-14, in this example. The multiple spot beams (e.g., beams 610, 612, 614, 616) of the satellite 310 may use different frequency intervals or different time intervals in the same BWP to reduce inter-beam interference for link budget improvement.

In an initial BWP (e.g., BWP #0) for inactive or idle mode UEs, beams 610, 612, 614, 616 may be time division multiplexed. For connected mode UEs, dedicated BWPs may be configured for each beam. In the example of FIG. 6, the different beams 610, 612, 614, 616 operate in different BWPs. For example, beam #3 610 operates in the same BWP as beam #6 616 but in a different BWP than beam #4 612 and beam #5 614, which each operate in their own different BWP.

Due to movement of the satellite 310, the UE 120 may experience frequent switching of spot beams 610, 612, 614, 616. In FIG. 6, the satellite 310 moves in the direction of an arrow 605. Consequently, the UE 120 traverses beams in the direction of an arrow 615 from spot beam 610 to spot beam 612, and then to spot beams 614 and 616. As an example, with a LEO satellite, one beam may only serve the UE for 20 seconds. As such, a BWP switching scheme is desirable to support satellite beam switching for idle/inactive mode UEs.

Due to satellite movement, for small data transmissions in an NTN, beam switching can be expected in some cases. For example, switching can be expected when the total small data transmission duration is more than 20 seconds due to a potentially large delay for waiting for a downlink application layer ACK or due to a long periodicity of a configured grant. In another example, a UE may be in an overlapping area of two beams when transmitting a first uplink packet, and beam switching may happen for subsequent uplink small data transmissions.

For idle/inactive mode UEs, the UE may not include a mechanism to report a switch of SSB beam for small data transmissions. It should also be noted that implementation of beam switch via a BWP switch, which is performed via DCI, MAC-CE, or RRC signalling, cannot be applied to small data transmission for idle/inactive mode UEs. That is, only an initial downlink and uplink BWP #0 is configured for the UE while in idle/inactive mode. The other BWPs, (e.g., BWP #1, BWP #2, BWP #3) are dedicated BWPs for connected mode UEs.

In order for idle/inactive mode UEs to switch beams, according to aspects of the present disclosure, an idle/inactive mode UE determines its location, and reports its location when sending a first uplink small data transmission to a base station (e.g., gNB). Based on the location, the network may preconfigure a beam switching time along with beam layout information to the UE. The UE may be capable of determining its location, for example, based on Global Navigation Satellite System (GNSS) techniques. Because the coverage track of a UE crossing beams may be approximated to a straight line, the action for beam switching may be determined based on the beam layout information and assistance information, such as location and/or speed information received from the UE. The UE may identify the switching, without further network assistance, once the beam switching time arrives.

FIG. 7 is a call flow diagram illustrating location-based beam switching, in accordance with aspects of the present disclosure. In FIG. 7, a UE 120 communicating with a base station 110 is in idle or inactive mode. At time t1, the UE 120 transmits a random access preamble to the base station 110. At time t2, the base station 110 responds with a random access response (RAR) message. At time t3, the UE 120 transmits a first uplink (UL) message with a small data transmission. At time t3, the UE 120 also includes an RRC resume request message, indicating the intent to resume a connection for the purpose of sending a small data transmission. Optionally, the UE 120 also sends a buffer status report (BSR) in a media access control-control element (MAC-CE). According to aspects of the present disclosure, the UE 120 reports its location when transmitting the first uplink small data message to the base station 110 at time t3. Based on the UE location, the network may preconfigure a beam switching time along with the beam layout information. At time t4, the base station 110 responds to the first uplink message with a network response message including a beam switch configuration. The beam switch configuration may include the beam switching time and the beam layout information. With the received beam switch configuration, for subsequent small data transmissions, the UE 120 may identify the switching automatically once the timer is satisfied.

Up until time t4, the UE 120 communicates during a PUSCH occasion corresponding with SSB beam x. Between times t4 and t5, the base station 110 switches its beam to SSB beam y in accordance with the timer. Thus, at time t5, subsequent small data transmissions are sent to the base station 110 during a PUSCH occasion corresponding to the new beam, such as the SSB beam y in the example of FIG. 7. At time t6, the base station 110 responds with downlink data in response to the received uplink data. The network may also reconfigure the UE's transmission configuration indicator (TCI) state based on the new beam for any downlink data transmission. At times t7 and t8, the UE 120 sends more uplink small data transmissions during the PUSCH occasions associated with SSB beam y. Finally, at time t9, the base station 110 releases the connection with an RRC release message, indicating a configuration for suspending the connection.

If the UE has no capability to determine its location, according to further aspects of the present disclosure, an idle/inactive mode UE may initiate a beam switching request during uplink small data transmission by using a contention-free random access channel (RACH) procedure or a physical uplink shared channel (PUSCH) message.

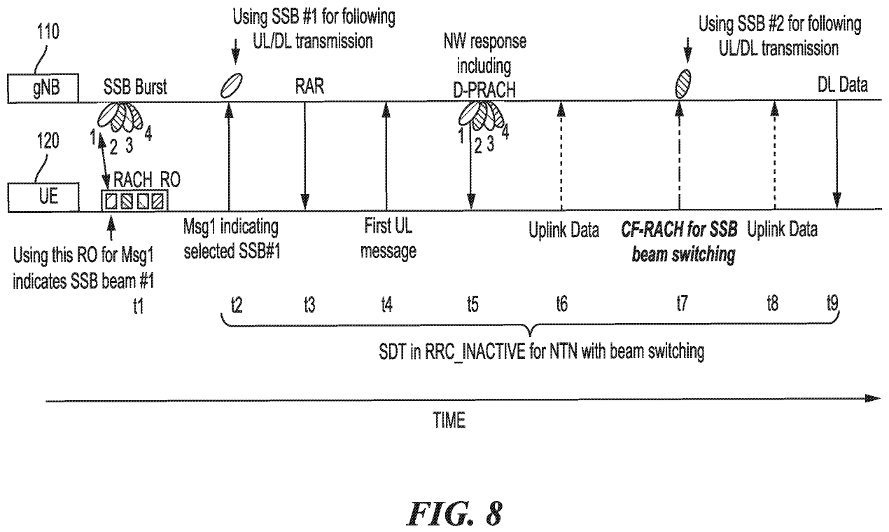

FIG. 8 is a diagram illustrating a timeline for beam switching based on a random access channel (RACH) message, in accordance with aspects of the present disclosure. In these aspects, a network may configure dedicated RACH resources for UE initiated beam switching in response to subsequent uplink small data transmissions while the UE remains in an inactive/idle state. Assuming each RACH occasion in the dedicated physical random access channel (PRACH) configuration corresponds to one of the SSB beams, if a beam switch is identified and a new serving beam is selected, the UE transmits its dedicated preamble in the RACH occasion corresponding to the selected beam for initiating the beam switch. The network will then use the new serving beam for receiving the subsequent uplink small data transmissions. The network may also reconfigure the UE's transmission configuration indicator (TCI) state based on the new serving beam for any downlink data transmission.

In the example of FIG. 8, at time t1, the network, for example a satellite base station 110, transmits a mapping between SSB beams and RACH occasions (ROs), with each beam corresponding to a different RO. By transmitting its preamble using a particular RACH occasion, which is mapped to a particular beam, a UE 120 may select a particular beam. For example, while in inactive or idle mode, at time t2, the UE 120 transmits the contention based preamble (e.g., Msg1) during a RACH occasion corresponding to SSB beam #1. As a result, the base station 110 uses SSB beam #1 for subsequent uplink and downlink communications. For example, at time t3, the base station 110 transmits the random access response (RAR) message using SSB beam #1.

At time t4, the UE 120 transmits a first uplink (UL) message with a small data transmission using a PUSCH occasion corresponding to SSB #1. At time t4, the UE 120 also includes an RRC resume request message, indicating the intent to resume a connection for the purpose of sending a small data transmission. Optionally, the UE 120 also sends a buffer status report (BSR) in a media access control-control element (MAC-CE). The UE may optionally report its capability for beam switching during a subsequent uplink data transmission. Based on the reported capability, the network may configure dedicated preamble resources for a beam switching request. If no capability is reported, the network does not configure the dedicated RACH resources for beam switching. In this case, beam switching for small data transmission is not supported and the UE may restart the small data transmission procedure to initiate a beam switch. At time t5, the base station 110 responds to the first uplink message with a network (NW) response message using SSB beam #1. The response message may include dedicated RACH resources for a UE to request a beam switch during a subsequent small data transmission. At time t6, the UE 120 transmits a subsequent uplink small data transmission during a PUSCH occasion corresponding to SSB beam #1.

Between times t6 and t7, the UE 120 determines it is time for a beam switch, for example, based on RSRP measurements on SSB beams. In this example, the UE 120 selects SSB beam #2. Thus, at time t7, the UE 120 transmits a dedicated preamble during a RACH occasion corresponding to selected SSB beam #2. As a result, the base station 110 uses SSB beam #2 for subsequent uplink and downlink communications. At time t8, the UE 120 transmits a subsequent uplink small data transmission during a PUSCH occasion corresponding to SSB beam #2. At time t9, the base station 110 responds with downlink data, in response to the received uplink data, on SSB beam #2.

In yet other aspects of the present disclosure, where the UE is not capable of determining its location, the network may enable the UE to request a beam switch via the PUSCH for subsequent uplink data transmissions. For example, the UE may multiplex a physical layer (L1) beam report on the PUSCH to indicate beam switching for later uplink or downlink transmissions. The L1 beam report may be configured by the network and may include an index for a selected SSB beam. The configuration may also include a beta offset value indicating a coding rate for the multiplexing. In these aspects, the network may also reconfigure the UE's transmission configuration indicator (TCI) state based on the new serving beam for any downlink data transmission.

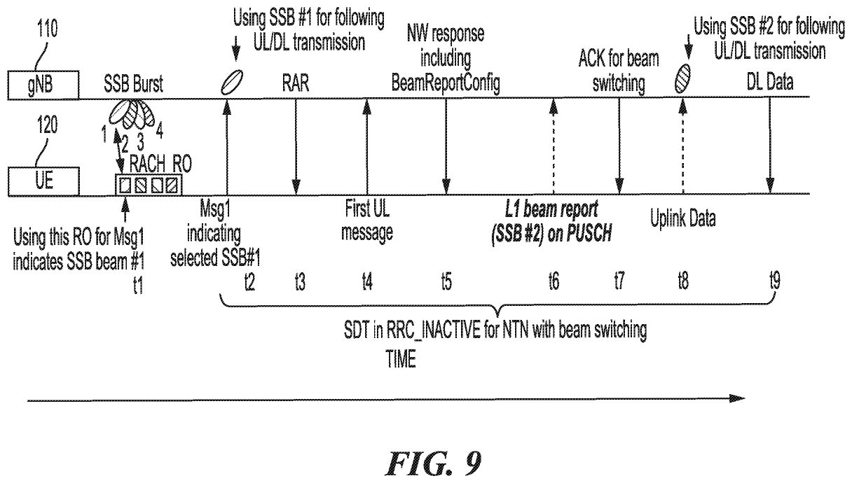

FIG. 9 is a diagram illustrating a timeline for beam switching based on a physical uplink shared channel (PUSCH) message, in accordance with aspects of the present disclosure. In the example of FIG. 9, at time t1, a network, for example a base station 110, transmits, to a UE 112, a mapping between SSB beams and contention-based RACH occasions (ROs), with each beam corresponding to a different RO. By transmitting its preamble using a particular RACH occasion, which is mapped to a particular beam, the UE 120 may select a particular beam. For example, while in inactive or idle mode, at time t2, the UE 120 transmits the preamble (e.g., Msg1) during a RACH occasion corresponding to SSB beam #1. As a result, the base station 110 uses SSB beam #1 for subsequent uplink and downlink communications. For example, at time t3, the base station 110 transmits the random access response (RAR) message using SSB beam #1.

At time t4, the UE 120 transmits a first uplink (UL) message with a small data transmission using a transmission occasion corresponding to SSB #1. At time t4, the UE 120 also includes an RRC resume request message, indicating the intent to resume a connection for the purpose of sending a small data transmission. Optionally, the UE 120 also sends a buffer status report (BSR) in a media access control-control element (MAC-CE). The UE may optionally report its capability for beam switching during a subsequent uplink data transmission. Based on the reported capability, the network may configure a L1 beam report to be multiplexed on the PUSCH for a beam switching request. At time t5, the base station 110 responds to the first uplink message with a network (NW) response message using SSB beam #1. The response message may include an indication for enabling L1 beam report multiplexed on the PUSCH for a UE requesting a beam switch during a subsequent small data transmission.

At time t6, the UE 120 determines it is time for a beam switch, for example, based on environmental conditions. In this example, the UE 120 selects SSB beam #2. Thus, at time t6, the UE 120 multiplexes an L1 beam report on the PUSCH. The L1 beam report may include an index to the selected SSB beam #2. In some aspects of the present disclosure, a betaOffset parameter may be configured for determining a coding rate for L1 beam report multiplexing on the PUSCH.

In response to receiving the L1 beam report, the base station 110 uses SSB beam #2 for subsequent uplink and downlink communications. The base station 110 may optionally transmit an acknowledgement to confirm the beam switching at time t7. At time t8, the UE 120 transmits a subsequent uplink small data transmission during a transmission occasion corresponding to SSB beam #2. At time t9, the base station 110 responds with downlink data, in response to the received uplink data, on SSB beam #2.

As indicated above, FIGS. 3-9 are provided as examples. Other examples may differ from what is described with respect to FIGS. 3-9.

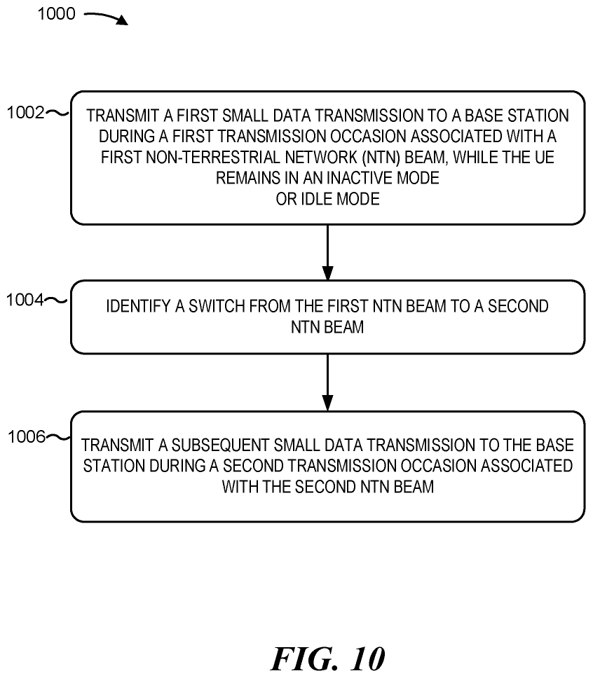

FIG. 10 is a flow diagram illustrating an example process 1000 performed, for example, by a UE, in accordance with various aspects of the present disclosure. The example process 1000 is an example of small data transmission with beam switching for non-terrestrial networks (NTNs).

At block 1002, the user equipment (UE) transmits a first small data transmission to a base station during a first transmission occasion associated with a first NTN beam, while the UE remains in an inactive mode or idle mode. For example, the UE (e.g., using the memory 282, controller/processor 280, the transmit processor 264, TX MIMO processor 266, MOD 254, and/or antenna 252) may transmit the data. The UE may also transmit a location of the UE along with the first small data transmission; and receive a beam switch configuration from the base station prior to the switch, the beam switch configuration comprising a beam switching time and beam layout information, the switch occurring at the beam switching time.

At block 1004, the user equipment (UE) identifies a switch from the first NTN beam to a second NTN beam. For example, the UE (e.g., using the controller/processor 280, and/or memory 282) may identify the switch. The UE may receive a beam switch configuration from the base station prior to the switch. The beam switch configuration may include a beam switching time and beam layout information. The switch occurs at the beam switching time. In some aspects, the UE may transmit a beam switch request prior to the switch. The beam switch request may be a dedicated preamble transmitted during a random access channel (RACH) occasion associated with the second NTN beam. In other aspects, the UE may transmit the beam switch request via a physical uplink shared channel (PUSCH), in accordance with a network configuration. in still other aspects, the UE may multiplex the beam switch request with a physical layer (L1) beam report. The beam switch request may be a selected synchronization signal block (SSB) index.

At block 1006, the user equipment (UE) transmits a subsequent small data transmission to the base station during a second transmission occasion associated with the second NTN beam. For example, the UE (e.g., using the memory 282, controller/processor 280, the transmit processor 264, TX MIMO processor 266, MOD 254, and/or antenna 252) may transmit a subsequent small data transmission.

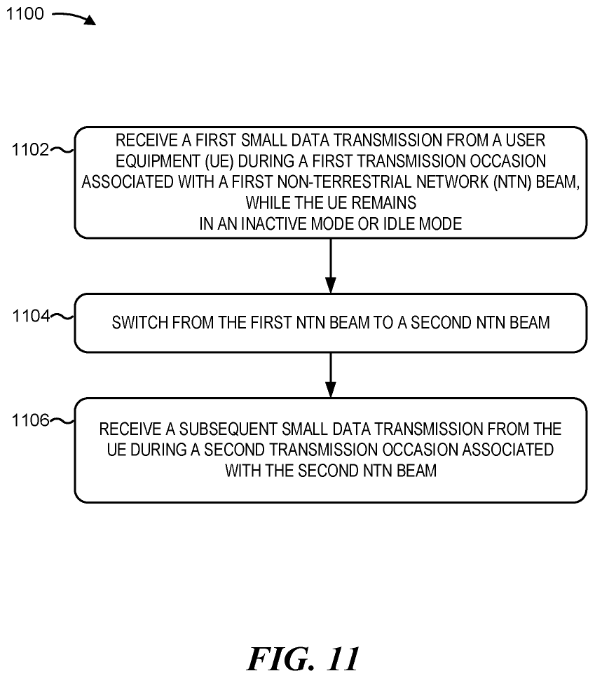

FIG. 11 is a flow diagram illustrating an example process 1100 performed, for example, by a base station, in accordance with various aspects of the present disclosure. The example process 1100 is an example of small data transmission with beam switching for non-terrestrial networks (NTNs).

At block 1102, the base station receives a first small data transmission from a user equipment (UE) during a first transmission occasion associated with a first NTN beam, while the UE remains in an inactive mode or idle mode. For example, the base station (e.g., using the antenna 234, DEMOD 232, MIMO detector 236, receive processor 238, controller/processor 240, and/or memory 242) may receive a small data transmission. The UE may receive a location of the UE along with the first small data transmission

At block 1104, the base station switches from the first NTN beam to a second NTN beam. For example, the base station (e.g., using the antenna 234, MIMO detector 236, TX MIMO processor 230, receive processor 238, transmit processor 220, controller/processor 240, MOD/DEMOD 232, and/or memory 242) may switch NTN beams. The base station may transmit a beam switch configuration to the UE prior to the switching, the beam switch configuration comprising a beam switching time and beam layout information. The switching occurs at the beam switching time. The base station may receive a beam switch request prior to the switching. In some aspects, the beam switch request is a dedicated preamble received during a random access channel (RACH) occasion associated with the second NTN beam. In other aspects, the base station receives the beam switch request via the PUSCH, in accordance with the network configuration.

At block 1106, the base station receives a subsequent small data transmission from the UE during a second transmission occasion associated with the second NTN beam. For example, the base station (e.g., using the antenna 234, MIMO detector 236, receive processor 238, DEMOD 232, controller/processor 240, and/or memory 242) may receive a subsequent small data transmission.

Implementation examples are described in the following numbered clauses.
1. A method of wireless communication by a user equipment (UE) in a non-terrestrial network (NTN), comprising:
   transmitting a first small data transmission to a base station during a first transmission occasion associated with a first NTN beam, while the UE remains in an inactive mode or idle mode;
   identifying a switch from the first NTN beam to a second NTN beam; and transmitting a subsequent small data transmission to the base station during a second transmission occasion associated with the second NTN beam.
2. The method of clause 1, further comprising:
   transmitting a location of the UE along with the first small data transmission; and
   receiving a beam switch configuration from the base station prior to the switch, the beam switch configuration comprising a beam switching time and beam layout information, the switch occurring at the beam switching time.
3. The method of clause 1, further comprising transmitting a beam switch request prior to the switch.
4. The method of any of clauses 1 or 3, further comprising receiving, from the base station, resources for a dedicated preamble, and the beam switch request comprises a dedicated preamble transmitted during a random access channel (RACH) occasion associated with the second NTN beam.
5. The method of any of clauses 1, 3, or 4, further comprising receiving a transmission configuration indicator (TCI) state reconfiguration for a downlink transmission based on the second NTN beam, after transmitting the beam switch request.
6. The method of any of clauses 1, 3, or 5, further comprising:
   receiving a network configuration for beam switch reporting via a physical uplink shared channel (PUSCH); and
   transmitting the beam switch request via the PUSCH, in accordance with the network configuration.
7. The method of any of clauses 1, 3, 5, or 6, further comprising multiplexing the beam switch request with a physical layer (L1) beam report.
8. The method of any of clauses 1, 3, 5, 6, or 7, in which the beam switch request comprises a selected synchronization signal block (SSB) index.
9. The method of any of clauses 1, 3, 5, 6, 7, or 8, in which the network configuration for beam switch reporting comprises a beta offset value indicating a coding rate for multiplexing.
10. The method of any of clauses 1, or 3-9, further comprising receiving an acknowledgment of the beam switch request from the base station.
11. A method of wireless communication by a base station in a non-terrestrial network (NTN), comprising:
   receiving a first small data transmission from a user equipment (UE) during a first transmission occasion associated with a first NTN beam, while the UE remains in an inactive mode or idle mode;
switching from the first NTN beam to a second NTN beam; and
   receiving a subsequent small data transmission from the UE during a second transmission occasion associated with the second NTN beam.
12. The method of clause 11, further comprising:
   receiving a location of the UE along with the first small data transmission; and
   transmitting a beam switch configuration to the UE prior to the switching, the beam switch configuration comprising a beam switching time and beam layout information, the switching occurring at the beam switching time.
13. The method of clause 11, further comprising receiving a beam switch request prior to the switching.
14. The method of any of the clauses 11 or 13, further comprising transmitting, to the UE, resources for a dedicated preamble, and the beam switch request comprises the dedicated preamble received during a random access channel (RACH) occasion associated with the second NTN beam.
15. The method of any of the clauses 11 or 13-14, further comprising transmitting a transmission configuration indicator (TCI) state reconfiguration for a downlink transmission based on the second NTN beam, after receiving the beam switch request.
16. The method of any of the clauses 11, 13 or 15, further comprising:
   transmitting a network configuration for beam switch reporting via a physical uplink shared channel (PUSCH); and
   receiving the beam switch request via the PUSCH, in accordance with the network configuration.
17. The method of any of the clauses 11, 13, 15, or 16, further comprising demultiplexing the beam switch request from a physical layer (L1) beam report.
18. The method of any of the clauses 11, 13, 15, 16, or 17, in which the beam switch request comprises a selected synchronization signal block (SSB) index.
19. The method of any of the clauses 11, 13, 15, 16, 17, or 18, in which the network configuration for beam switch reporting comprises a beta offset value indicating a coding rate for multiplexing.
20. The method of any of the clauses 11, or 13-19, further comprising transmitting an acknowledgment of the beam switch request to the UE.
21. An apparatus for wireless communication by a user equipment (UE), comprising:
   a memory; and
   at least one processor coupled to the memory, the at least one processor configured:
      to transmit a first small data transmission to a base station during a first transmission occasion associated with a first NTN beam, while the UE remains in an inactive mode or idle mode;
   to identify a switch from the first NTN beam to a second NTN beam; and
   to transmit a subsequent small data transmission to the base station during a second transmission occasion associated with the second NTN beam.
22. The apparatus of clause 21, in which the at least one processor is further configured:
   to transmit a location of the UE along with the first small data transmission; and
   to receive a beam switch configuration from the base station prior to the switch, the beam switch configuration comprising a beam switching time and beam layout information, the switch occurring at the beam switching time.
23. The apparatus of clause 21, in which the at least one processor is further configured to transmit a beam switch request prior to the switch.
24. The apparatus of any of the clauses 21 or 23, in which the at least one processor is further configured to receive, from the base station, resources for a dedicated preamble, and the beam switch request comprises a dedicated preamble transmitted during a random access channel (RACH) occasion associated with the second NTN beam.
25. The apparatus of any of the clauses 21, 23, or 24, in which the at least one processor is further configured to receive a transmission configuration indicator (TCI) state reconfiguration for a downlink transmission based on the second NTN beam, after transmitting the beam switch request.
26. The apparatus of any of the clauses 21, 23, or 25, in which the at least one processor is further configured:
   to receive a network configuration for beam switch reporting via a physical uplink shared channel (PUSCH); and
   to transmit the beam switch request via the PUSCH, in accordance with the network configuration.
27. The apparatus of any of the clauses 21, 23, 25, or 26, in which the at least one processor is further configured to multiplex the beam switch request with a physical layer (L1) beam report.
28. The apparatus of any of the clauses 21, 23, 25, 26, or 27, in which the beam switch request comprises a selected synchronization signal block (SSB) index.
29. The apparatus of any of the clauses 21, 23, 25, 26, 27, or 28, in which the network configuration for beam switch reporting comprises a beta offset value indicating a coding rate for multiplexing.
30. The apparatus of any of the clauses 21, or 23-29, in which the at least one processor is further configured to receive an acknowledgment of the beam switch request from the base station.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE) in a non-terrestrial network (NTN), comprising:
transmitting a first small data transmission to a base station during a first transmission occasion associated with a first NTN beam, while the UE remains in an inactive mode or idle mode;
identifying a switch from the first NTN beam to a second NTN beam; and
transmitting a subsequent small data transmission to the base station during a second transmission occasion associated with the second NTN beam.

2. The method of claim 1, further comprising:
transmitting a location of the UE along with the first small data transmission; and
receiving a beam switch configuration from the base station prior to the switch, the beam switch configuration comprising a beam switching time and beam layout information, the switch occurring at the beam switching time.

3. The method of claim 1, further comprising transmitting a beam switch request prior to the switch.

4. The method of claim 3, further comprising receiving, from the base station, resources for a dedicated preamble, and the beam switch request comprises the dedicated preamble transmitted during a random access channel (RACH) occasion associated with the second NTN beam.

5. The method of claim 3, further comprising receiving a transmission configuration indicator (TCI) state reconfiguration for a downlink transmission based on the second NTN beam, after transmitting the beam switch request.

6. The method of claim 3, further comprising:
receiving a network configuration for beam switch reporting via a physical uplink shared channel (PUSCH); and
transmitting the beam switch request via the PUSCH, in accordance with the network configuration.

7. The method of claim 6, further comprising multiplexing the beam switch request with a physical layer (L1) beam report.

8. The method of claim 7, in which the beam switch request comprises a selected synchronization signal block (SSB) index.

9. The method of claim 6, in which the network configuration for beam switch reporting comprises a beta offset value indicating a coding rate for multiplexing.

10. The method of claim 6, further comprising receiving an acknowledgment of the beam switch request from the base station.

11. A method of wireless communication by a base station in a non-terrestrial network (NTN), comprising:
receiving a first small data transmission from a user equipment (UE) during a first transmission occasion associated with a first NTN beam, while the UE remains in an inactive mode or idle mode;
switching from the first NTN beam to a second NTN beam; and
receiving a subsequent small data transmission from the UE during a second transmission occasion associated with the second NTN beam.

12. The method of claim 11, further comprising:
receiving a location of the UE along with the first small data transmission; and
transmitting a beam switch configuration to the UE prior to the switching, the beam switch configuration comprising a beam switching time and beam layout information, the switching occurring at the beam switching time.

13. The method of claim 11, further comprising receiving a beam switch request prior to the switching.

14. The method of claim 13, further comprising transmitting, to the UE, resources for a dedicated preamble, and the beam switch request comprises the dedicated preamble received during a random access channel (RACH) occasion associated with the second NTN beam.

15. The method of claim 13, further comprising transmitting a transmission configuration indicator (TCI) state reconfiguration for a downlink transmission based on the second NTN beam, after receiving the beam switch request.

16. The method of claim 13, further comprising:
transmitting a network configuration for beam switch reporting via a physical uplink shared channel (PUSCH); and
receiving the beam switch request via the PUSCH, in accordance with the network configuration.

17. The method of claim 16, further comprising demultiplexing the beam switch request from a physical layer (L1) beam report.

18. The method of claim 17, in which the beam switch request comprises a selected synchronization signal block (SSB) index.

19. The method of claim 16, in which the network configuration for beam switch reporting comprises a beta offset value indicating a coding rate for multiplexing.

20. The method of claim 16, further comprising transmitting an acknowledgment of the beam switch request to the UE.

21. An apparatus for wireless communication by a user equipment (UE), comprising:
a memory; and
at least one processor coupled to the memory, the at least one processor configured:
to transmit a first small data transmission to a base station during a first transmission occasion associated with a first NTN beam, while the UE remains in an inactive mode or idle mode;
to identify a switch from the first NTN beam to a second NTN beam; and
to transmit a subsequent small data transmission to the base station during a second transmission occasion associated with the second NTN beam.

22. The apparatus of claim 21, in which the at least one processor is further configured:
to transmit a location of the UE along with the first small data transmission; and
to receive a beam switch configuration from the base station prior to the switch, the beam switch configuration comprising a beam switching time and beam layout information, the switch occurring at the beam switching time.

23. The apparatus of claim 21, in which the at least one processor is further configured to transmit a beam switch request prior to the switch.

24. The apparatus of claim 23, in which the at least one processor is further configured to receive, from the base station, resources for a dedicated preamble, and the beam switch request comprises the dedicated preamble transmitted during a random access channel (RACH) occasion associated with the second NTN beam.

25. The apparatus of claim 23, in which the at least one processor is further configured to receive a transmission configuration indicator (TCI) state reconfiguration for a downlink transmission based on the second NTN beam, after transmitting the beam switch request.

26. The apparatus of claim 23, in which the at least one processor is further configured:
to receive a network configuration for beam switch reporting via a physical uplink shared channel (PUSCH); and
to transmit the beam switch request via the PUSCH, in accordance with the network configuration.

27. The apparatus of claim 26, in which the at least one processor is further configured to multiplex the beam switch request with a physical layer (L1) beam report.

28. The apparatus of claim 27, in which the beam switch request comprises a selected synchronization signal block (SSB) index.

29. The apparatus of claim 26, in which the network configuration for beam switch reporting comprises a beta offset value indicating a coding rate for multiplexing.

30. The apparatus of claim 26, in which the at least one processor is further configured to receive an acknowledgment of the beam switch request from the base station.
